(19) United States
(12) Patent Application Publication
(10) Pub. No.: US 2013/0314651 A1
(43) Pub. Date: Nov. 28, 2013

(54) DISPLAY APPARATUS

(71) Applicant: SAMSUNG DISPLAY CO., LTD., Yongin-City (KR)

(72) Inventors: Seongmo HWANG, Seongnam-si (KR); Moongyu LEE, Suwon-si (KR); Jaeho YOU, Gwangmyeong-si (KR)

(73) Assignee: SAMSUNG DISPLAY CO., LTD., Yongin-City (KR)

(21) Appl. No.: 13/686,132

(22) Filed: Nov. 27, 2012

(30) Foreign Application Priority Data
May 23, 2012 (KR) 10-2012-0054992

(51) Int. Cl. G02F 1/1335

(52) U.S. Cl. CPC G02F 1/133509
USPC 349/104

(57) ABSTRACT

A display apparatus including a display panel configured to display an image, and a wavelength selective transflective member configured to transmit a light corresponding to at least one wavelength band of an incident light, to reflect a light corresponding to at least one remaining wavelength band, and to provide the display panel with the transmitted light or the reflected light. The transmitted light or the reflected light has a plurality of separated wavelength bands.

### CROSS-REFERENCE TO RELATED APPLICATION

This application claims priority from and the benefit of Korean Patent Application No. 10-2012-0054992, filed on May 23, 2012, which is hereby incorporated by reference for all purposes as if fully set forth herein.

### BACKGROUND FIELD

Exemplary embodiments of the present invention relate to a display apparatus. More particularly, exemplary embodiments of the present invention relate to a transflective type display apparatus.

### DISCUSSION OF THE BACKGROUND

In general, non-emissive display apparatuses, such as liquid crystal displays, are divided into a transmissive type display apparatus and a reflective type display apparatus, according to a light source.

The transmissive type display apparatus uses a backlight as a light source and displays information by transmitting a light emitted from the backlight through a transparent electrode. Therefore, the transmissive type display apparatus can provide viewers with high-brightness images. The reflective type display apparatus uses a metal having a high reflective ratio and reflecting an external light, instead of the backlight, to display information. Therefore, the reflective type display apparatus exhibits low power consumption.

Recently, a transflective type display apparatus combining the advantages of the transmissive type display apparatus and the reflective type display apparatus has been developed. However, because each pixel region of the transflective type display apparatus is divided into a transmissive region and a reflective region, brightness and resolution of the transflective type display apparatus may be degraded.

### SUMMARY

Exemplary embodiments of the present invention provide a transflective type display apparatus having improved brightness and resolution.

Additional features of the invention will be set forth in the description which follows, and in part will be apparent from the description, or may be learned by practice of the invention.

An exemplary embodiment of the present invention discloses a display apparatus including a display panel configured to display an image and a wavelength selective transflective member configured to transmit a light corresponding to predetermined wavelength bands of an incident light, to reflect a light corresponding to remaining wavelength bands, and to provide the display panel with the transmitted light or the reflected light. The transmitted light has a plurality of separated wavelength bands.

An exemplary embodiment of the present invention also discloses a display apparatus including a display panel configured to display an image and a wavelength selective transflective member configured to transmit a light corresponding to predetermined wavelength bands of an incident light, to reflect a light corresponding to remaining wavelength bands, and to provide the display panel with the transmitted light or the reflected light. The wavelength selective transflective member may further include a base substrate, and a plurality of filter units disposed on the base substrate. The filter units are configured to reflect a light corresponding to a plurality of separated wavelength bands of the remaining wavelength bands.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a perspective view illustrating a display apparatus according to an exemplary embodiment of the present invention.

FIG. 2, FIG. 3, FIG. 4, and FIG. 5 are conceptual views illustrating an operation of the display apparatus shown in FIG. 1.

FIG. 6 is a graph illustrating a spectrum of a light transmitted from a display panel after being emitted from a backlight unit.

FIG. 7 is a graph illustrating a spectrum of an external light transmitted from a color filter after being incident from an exterior.

FIG. 8 is a graph illustrating a spectrum of the external light reflected by a wavelength selective transflective member after being transmitted from the color filter.

FIG. 9 and FIG. 10 are cross-sectional views illustrating the wavelength selective transflective member shown in FIG. 1

FIG. 11 is a graph illustrating a light transmitted from the wavelength selective transflective member shown in FIG. 9 and FIG. 10;

FIG. 12 is cross-sectional view illustrating a wavelength selective transflective member used in a display apparatus according to an exemplary embodiment of the present invention.

FIG. 13, FIG. 14, FIG. 15, and FIG. 16 are graphs illustrating a spectrum of a light transmitted from each filter unit of the wavelength selective transflective member shown in FIG. 12.

FIG. 17 is a graph illustrating a spectrum of a light transmitted from the wavelength selective transflective member shown in FIG. 12.

FIG. 18 is a cross-sectional view illustrating a wavelength selective transflective member used in a display apparatus according to an exemplary embodiment of the present invention.

FIG. 19 and FIG. 20 are graphs illustrating a spectrum of a light transmitted from each filter unit of the wavelength selective transflective member shown in FIG. 18.

FIG. 21 is a graph illustrating a spectrum of a light transmitted from the wavelength selective transflective member shown in FIG. 18.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. It will be understood that for the purposes of this disclosure, “at least one of X, Y, and Z” can be construed as X only, Y only, Z only, or any combination of two or more items X, Y, and Z (e.g., XYZ, XYY, YZ, ZZ). As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present invention will be explained in detail with reference to the accompanying drawings.

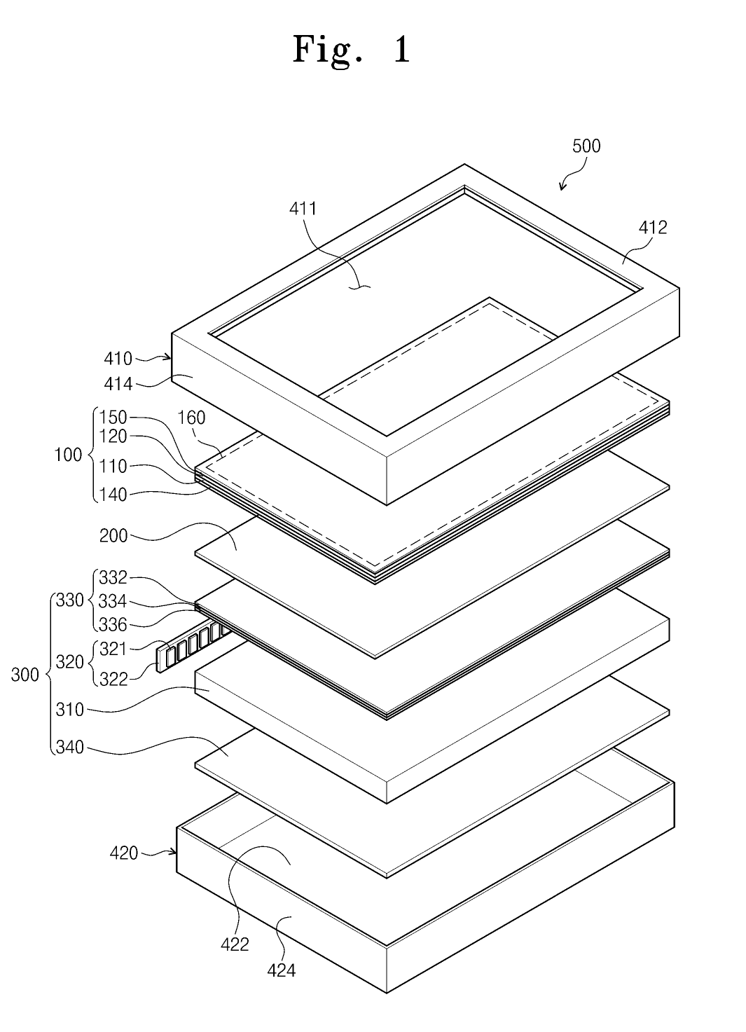

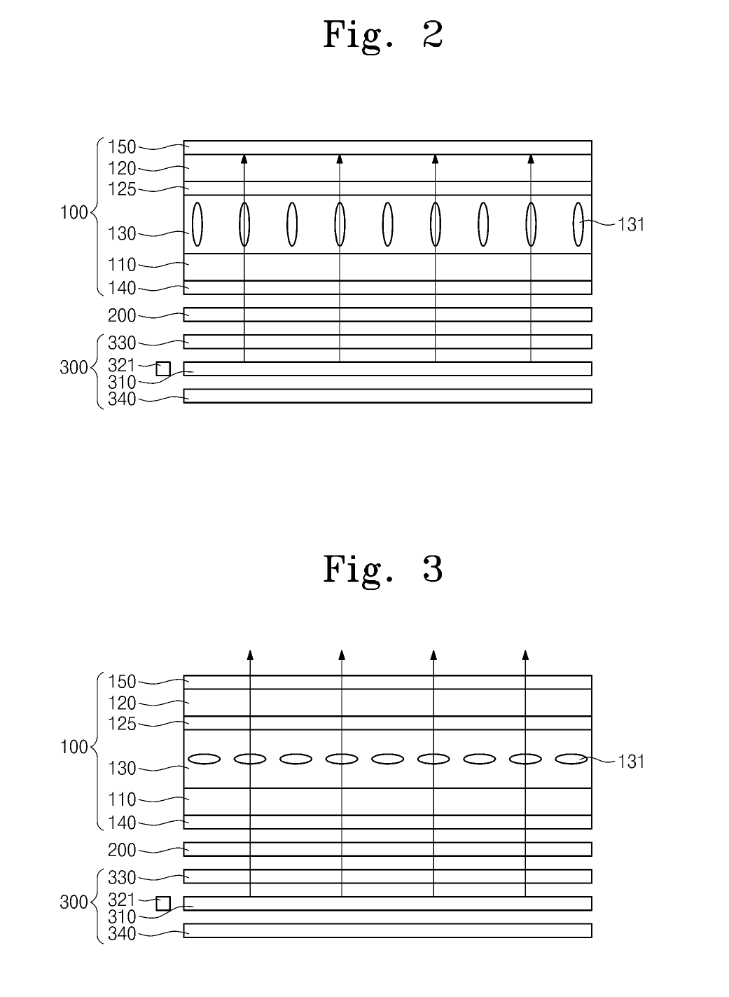

FIG. 1 is a perspective view illustrating a display apparatus according to an exemplary embodiment of the present invention. FIG. 2 to FIG. 5 are conceptual views illustrating an operation of the display apparatus shown in FIG. 1. FIG. 2 to FIG. 5 show a display panel, a wavelength selective transflective member, and a backlight unit of the display apparatus.

Referring to FIG. 1 to FIG. 5, a display apparatus 500 according to an exemplary embodiment of the present invention includes a display panel 100, a wavelength selective transflective member 200, a backlight unit 300, an upper cover 410, and a lower cover 420.

The display panel 100 may use various types of display panels. For example, the display apparatus 500 may use one of a liquid crystal display panel, an electrophoretic display panel, an embedded micro-cavity display panel and an electrowetting display panel as the display panel 100. In the exemplary embodiment, the display apparatus 500 uses a liquid crystal display panel as the display panel 100.

The display panel 100 has a rectangular plate shape and displays images in a display region 160. Here, two sides of the display panel 100 have a length greater than that of the other two sides. The display panel 100 includes an array substrate 110, an opposite substrate 120 facing the array substrate 110, and a liquid crystal layer 130 between the array substrate 110 and the opposite substrate 120. A first polarization film 140 and a second polarization film 150 are attached to outer surfaces of the array substrate 110 and the opposite substrate 120, respectively. The first polarization film 140 has a transmittance axis substantially perpendicular to that of the second polarization film 150.

In an exemplary embodiment, the array substrate 110 includes a plurality of pixels (not shown) arranged in a matrix shape. Each pixel includes a plurality of sub-pixels, and each sub-pixel has a different color. For example, each sub-pixel may be a red, green, or blue color. Therefore, a light output from the each sub-pixel has a red, green, or blue color. In addition, each pixel includes a gate line (not shown), a data line (not shown), and a pixel electrode (not shown). The data line crosses with and is insulated from the gate line. Each pixel further includes a thin film transistor (not shown) electrically connected to the gate line, the data line, and the pixel electrode. The thin film transistor can switch a driving signal applied to the pixel electrode.

A driving integrated circuit (IC) (not shown) is disposed on one side of the array substrate 110. The driving IC receives various control signals from outside of the display apparatus 500 and provides the driving signal driving the display panel 100 to the thin film transistor in response to various control signals.

A color filter 125 is disposed on one surface of the opposite substrate 120 and represents a predetermined color using a light provided from the backlight unit 300 and a common electrode (not shown) disposed on the color filter 125 to face the pixel electrode. Here, the color filter 125 has a red, green or blue color, and is formed via a process, such as a deposition process or a coating process. In the exemplary embodiment, the color filter 125 may be disposed on the opposite substrate 120, but the present invention should not be limited to this arrangement. For example, the color filter 125 may be formed on the array substrate 110.

The liquid crystal layer 130 is arranged in a specific direction by voltages applied to the pixel electrode and the common electrode, and controls a transmittance of the light provided from the backlight unit 300. Therefore, the display panel 100 may display desired images.

The wavelength selective transflective member 200 is disposed between the display panel 100 and the backlight unit 300. In addition, the wavelength selective transflective member 200 transmits a light corresponding to predetermined wavelength bands of an incident light and reflects a light corresponding to remaining wavelength bands except the predetermined wavelength bands. In this case, the light transmitted from the wavelength selective transflective member 200 has a plurality of separated wavelength bands and is provided to the display panel 100. For example, the light transmitted from the wavelength selective transflective member 200 has a first wavelength band, a second wavelength band, and a third wavelength band.

The wavelength selective transflective member 200 provides the display panel 100 with the light as described below.

Whenever the display panel 100 displays the images using the light provided from the backlight unit 300, the wavelength selective transflective member 200 transmits a light having predetermined wavelength bands of the light provided from the backlight unit 300. When the display panel 100 displays the images using the external light instead the light provided from the backlight unit 300, the wavelength selective transflective member 200 reflects a light having predetermined wavelength bands of the external light and provides the display panel 100 with the reflected light.

The backlight unit 300 is disposed on a side opposite a side of the display panel 100 on which the images are displayed. The backlight unit 300 includes a light guide plate 310, a light source unit 320 having a plurality of light sources 321, an optical member 330, and a reflection sheet 340.

The light guide plate 310 is positioned under the display panel 100 and guides the light from the light source unit 320 toward the display panel 100. The light guide plate 310 overlaps with at least the display region 160 of the display panel 100. Here, the light guide plate 310 includes an output surface outputting the light, a lower surface facing the outputting surface, and side surfaces connecting the outputting surface with the lower surface. In addition, at least one of the side surfaces is an incident surface that faces the light source unit 320 to receive the light from the light source unit 320, and a side surface facing the incident surface is an opposite surface reflecting the incident light.

The light source unit 320 has a structure for mounting the light sources 321, such as a plurality of light emitting diodes on a printed circuit board 322. The light sources 321 emit the light having different colors from each other. For example, some of the light sources 321 emit a red color, others of the light sources 321 emit a green color, and the others of the light sources 321 emit a blue color. Also, the light sources 321 may have a full width at half maximum (FWHM) less than about 20°.

The light source unit 320 is disposed to face at least one side surface of the side surfaces of the light guide plate 310 and provides the light to the display panel 100 via the light guide plate 310, so that the display panel 100 displays the images using the light.

The optical member 330 is provided between the light guide plate 310 and the display panel 100. The optical member 330 controls the light that is provided from light source unit 320 and output through the light guide plate 310. In addition, the optical member 330 includes a diffusion sheet 336, a prism sheet 334 and a protection sheet 332, all being sequentially stacked.

The diffusion sheet 336 diffuses the light output from the light guide plate 310. The prism sheet 334 concentrates the light diffused by the diffusion sheet 336 in a direction substantially perpendicular to a plan surface of the display panel 100. Most of the light passing through the prism sheet 334 is vertically incident to the display panel 100. The protection sheet 332 is positioned on the prism sheet 334. The protection sheet 332 protects the prism sheet 334 from external shocks.

In the exemplary embodiment, the optical member 330 may include a single diffusion sheet 336, a single prism sheet 334, and a single protection sheet 332, but the present invention should not be limited to this arrangement. In particular, at least one of the diffusion sheet 336, the prism sheet 334 and the protection sheet 332 includes multiple sheets which are sequentially stacked. Also, at least one of the diffusion sheet 336, the prism sheet 334 and the protection sheet 332 may be omitted from the optical member 330.

The reflection sheet 340 is disposed under the light guide plate 310. The reflection sheet 340 reflects a light leaked from the light guide plate 310 without being provided toward the display panel 100 of the light emitted from the light source unit 320 to change a path of the leaked light toward the display panel 100. The reflection sheet 340 includes a material configured to reflect light. The reflection sheet 340 is disposed on the lower cover 420 and reflects the light generated from the light source unit 320. As a result, the reflection sheet 340 increases the amount of the light provided toward the display panel 100.

In the exemplary embodiment, the light source unit 320 may be disposed adjacent the side surface of the light guide plate 310 to provide the light toward the side surface of the light guide plate 310, but the present invention should not be limited to this arrangement. For example, the light source unit 320 may be disposed under the light guide plate 310 to provide the light toward the lower surface of the light guide plate 310. In addition, the light guide plate 310 may be omitted from the backlight unit 300. In this case, the light source unit 320 may be positioned under the display panel 100 and the light emitted from the light source unit 320 may be directly provided to the display panel 100.

The upper cover 410 is disposed on the display panel 100 and has a shape corresponding to a shape of the display panel 100. The upper cover 410 includes an upper surface 412 which supports edge portions of a front surface of the display panel 100 and has a display window 411 exposing the display region 160 of the display panel 100, and a side surface 414 which is extended from the upper surface 412 and bent toward the lower cover 420. Since the display panel 100 has a square plate shape, the side surface 414 of the upper cover 410 includes four side surfaces. The upper cover 410 couples with the lower cover 420 and supports the edge portions of the front surface of the display panel 100.

The lower cover 420 is disposed under the backlight unit 300. The lower cover 420 includes a bottom surface 422 corresponding to a shape of the display panel 100 and the backlight unit 300, and a side surface 424 which extends from the bottom surface 422 and bends toward the upper cover 410. Because the display panel 100 and the backlight unit 300 have a square plate shape, the side surface 424 of the lower cover 420 includes four side surfaces. The lower cover 420 provides a space configured to receive the display panel 100 and the backlight unit 300, and the space is defined by the bottom surface 422 and the side surface 424 of the lower cover 420. Also, the lower cover 420 couples with the upper cover 410 to receive the display panel 100 and the backlight unit 300 in an inner space formed between the lower cover 420 and the upper cover 410 and to support the display panel 100 and the backlight unit 300.

Hereinafter, an operation of the display apparatus 500 will be described.

Whenever the external light is not provided to the display apparatus 500 or a power source is not applied to the light source unit 320, the display apparatus 500 maintains a dark state since no light is provided to the display panel 100. When the display apparatus 500 maintains the dark state, a viewer cannot view the images via the display apparatus 500.

As shown in FIG. 2 and FIG. 4, if the power source is not applied to the display panel 100, the display apparatus 500 maintains the dark state regardless of the presence or absence of the light from the backlight unit 300 or the external light. Accordingly, when the display apparatus 500 maintains the dark state, the viewer cannot view the images via the display apparatus 500.

Hereinafter, more detail about the case of maintaining the dark state by the display apparatus 500 will be described.

As shown in FIG. 2, when the power source is applied to the light source unit 320, the light source 321 generates a light, and the generated light is provided to the wavelength selective transflective member 200 via the light guide plate 310 and the optical member 330.

One portion of the light provided to the wavelength selective transflective member 200, for example, a blue color light having a wavelength band of about 463 nm to about 475 nm, a green color light having a wavelength band of about 520 nm to about 538 nm, and a red color light having a wavelength band of about 614 nm to about 630 nm, is transmitted from the wavelength selective transflective member 200 and is provided to the display panel 100. Also, remaining wavelength bands of the light provided to the wavelength selective transflective member 200 are reflected by the wavelength selective transflective member 200.

Only light components substantially parallel to the transmittance axis of the first polarization film 140 of the light provided to the display panel 100 may be provided to the liquid crystal layer 130.

Whenever the power source is not applied to the display panel 100, an electric field is not formed between the array substrate 110 and the opposite substrate 120. Therefore, liquid crystal molecules in the liquid crystal layer 130 maintain an initial arrangement state. For example, the liquid crystal molecules 131 are arranged in a direction substantially perpendicular to surfaces of the array substrate 110 and the opposite substrate 120. Accordingly, the phase of the light provided to the liquid crystal layer 130 is not changed by the liquid crystal molecules 131 and maintains a state substantially parallel to the transmittance axis of the first polarization film 140.

Because the light transmitted from the liquid crystal layer 130 is substantially parallel to the transmittance axis of the first polarization film 140 and is substantially perpendicular to the transmittance axis of the second polarization film 150, the light cannot be transmitted through the second polarization film 150. In other words, the light that is generated from the light source 321 of the backlight unit 300 and provided to the display panel 100 cannot be transmitted to the display panel 100. Therefore, there is no light output from the display panel 100, and the display apparatus 500 maintains the dark state. Accordingly, the viewer can not view the images via the display apparatus 500.

As shown in FIG. 4, when the power source is not applied to the light source unit 320 and the external light is provided to the display panel 100, the external light is transmitted through the second polarization film 150 and is provided to the liquid crystal layer 130. Here, the light provided to the liquid crystal layer 130 includes light components substantially parallel to the transmittance axis of the second polarization film 150.

Whenever the light is provided to the liquid crystal layer 130 in a state in which the power source is not applied to the display panel 100, the phase of the light cannot be changed by the liquid crystal molecules 131.

Because the phase of the light transmitted from the liquid crystal layer 130 is not changed, the phase of the light may maintain a state substantially parallel to the transmittance axis of the second polarization film 150 and substantially perpendicular to the transmittance axis of the first polarization film 140. Therefore, the light transmitted from the liquid crystal layer 130 cannot be transmitted through the first polarization film 140. In other words, the external light provided to the display panel 100 is blocked by the first polarization film 140 and cannot be reflected by the wavelength selective transflective member 200. As a result, because the external light cannot be reflected by the wavelength selective transflective member 200, the light output from the display panel 100 does not exist, and the display apparatus 500 maintains the dark state. Accordingly, the viewer cannot view the images via the display apparatus 500.

As shown in FIG. 3, when the power source is applied to the display panel 100, the light generated from the backlight unit 300 transmits the display panel 100 and the display apparatus 500 may maintain a bright state in which the images are displayed.

In addition, referring to FIG. 5, when the power source is not applied to the light source unit 320, the external light is reflected by the wavelength selective transflective member 200 after being transmitted from the display panel 100 and is again transmitted through the display panel 100. Therefore, the display apparatus 500 may maintain a bright state capable of displaying the images. Accordingly, the viewer can view the images via the display apparatus 500.

Hereinafter, the case of maintaining the bright state by the display apparatus 500 will be described in more detail.

Referring to FIG. 3, when the power source is applied to the light source unit 320, the light source 321 generates the light. The light generated from the light source 321 is provided to the display panel 100 via the light guide plate 310, the optical member 330, and the wavelength selective transflective member 200.

Only light components substantially parallel to the transmittance axis of the first polarization films 140 of the light provided to the display panel 100 may be provided to the liquid crystal layer 130.

On the other hand, when the power source is applied to the display panel 100, an electric field is formed between the array substrate 110 and the opposite substrate 120. The liquid crystal molecules 131 are rearranged by the electric field and maintain a different arrangement state from the initial arrangement state. For example, the liquid crystal molecules 131 are rearranged in a direction substantially parallel to surfaces of the array substrate 110 and the opposite substrate 120 by the electric field. Accordingly, the phase of the light provided to the liquid crystal layer 130 may be changed by the liquid crystal molecules 131. The phase of the light transmitted from the first polarization film 140 and including components substantially parallel to the transmittance axis of the first polarization film 140 may be changed to be substantially perpendicular to the transmittance axis of the first polarization film 140.

Because the light transmitted from the liquid crystal layer 130 is substantially perpendicular to the transmittance axis of the first polarization film 140 and substantially parallel to the transmittance axis of the second polarization film 150, the light can be transmitted from the second polarization film 150. The light generated from the light source 321 of the backlight unit 300 and provided to the display panel 100 is transmitted from the display panel 100, and thus the display apparatus 500 maintains the bright state. Accordingly, the viewer can view the images via the display apparatus 500.

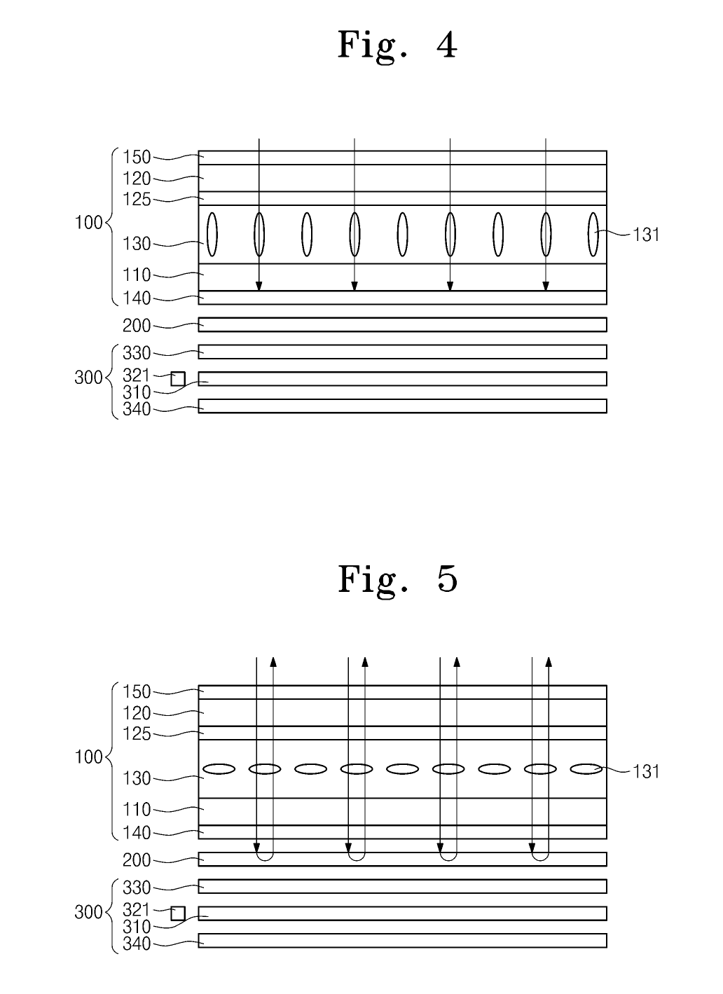

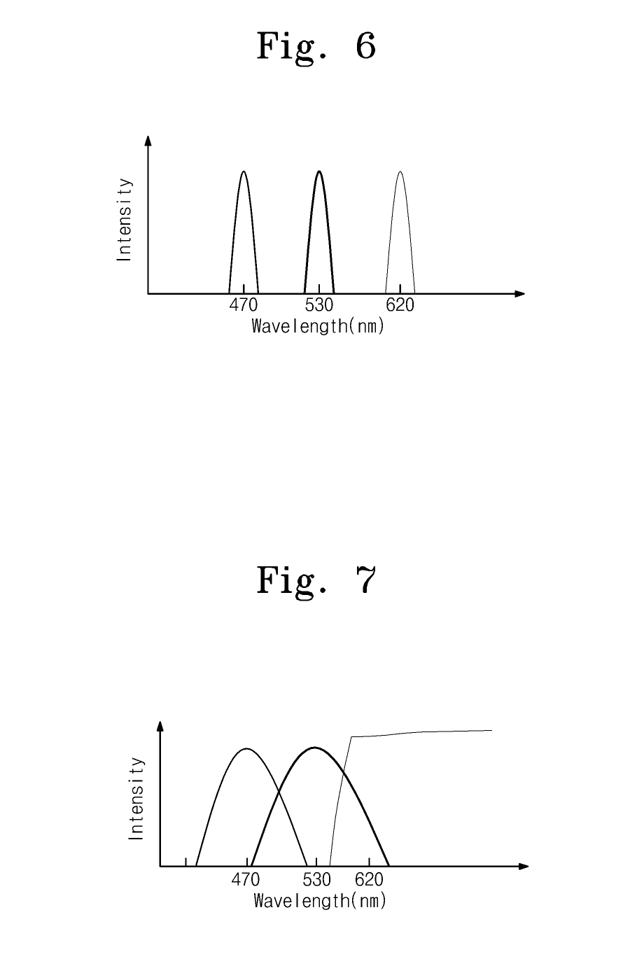

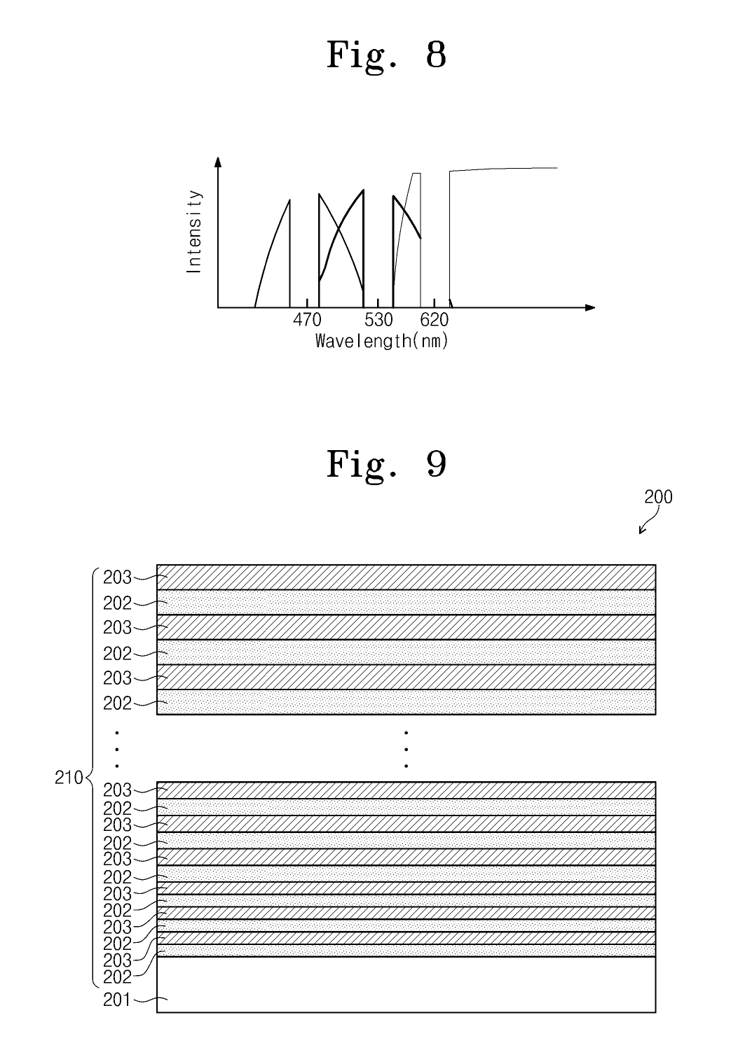

FIG. 6 is a graph illustrating a spectrum of a light transmitted from a display panel after being emitted from a backlight unit, FIG. 7 is a graph illustrating a spectrum of an external light transmitted from a color filter after being incident from an exterior, and FIG. 8 is a graph illustrating a spectrum of the external light reflected by a wavelength selective transflective member after being transmitted from the color filter.

The light transmitted from the display panel 100 has a spectrum as shown in FIG. 6. In particular, the light transmitted from the display panel 100 is a light which is generated from the light source 321, is sequentially transmitted from the wavelength selective transflective member 200 and the color filter 125 of the display panel 100, and is outputted from the display panel 100. Therefore, the light transmitted from the display panel 100 has a spectrum similar to that of the light transmitted from the wavelength selective transflective member 200.

As shown in FIG. 5, when the power source is not applied to the light source unit 320 and the external light is provided to the display panel 100, the external light is provided to the liquid crystal layer 130 after being transmitted from the second polarization film 150 and the color filer 125. Here, the light provided to the liquid crystal layer 130 may include components substantially parallel to the transmittance axis of the second polarization film 150, and the spectrum of the light may be varied according to the color of the color filter 125. For example, the light provided to the liquid crystal layer 130 may have a spectrum characteristic as shown in FIG. 7.

In addition, because the power source is applied to the display panel 100, the phase of the light provided to the liquid crystal layer 130 is changed, and thus the light may include components substantially perpendicular to the transmittance axis of the second polarization film 150 and substantially parallel to the transmittance axis of the first polarization film 140.

Because the light transmitted from the liquid crystal layer 130 has a characteristic substantially parallel to the transmittance axis of the first polarization film 140, the light is provided to the wavelength selective transflective member 200 passing through the first polarization film 140.

Some wavelength bands of the light provided to the wavelength selective transflective member 200 are reflected by the wavelength selective transflective member 200, and remaining wavelength bands of the light provided to the wavelength selective transflective member 200 are transmitted from the wavelength selective transflective member 200. The reflected light transmitted from the wavelength selective transflective member 200 has a spectrum characteristic as shown in FIG. 8. In particular, wavelength bands of the reflected light from the wavelength selective transflective member 200 may be defined as wavelength bands other than wavelength bands of the light transmitted from the wavelength selective transflective member 200 of a visible light wavelength band.

The reflected light from the wavelength selective transflective member 200 has a characteristic substantially parallel to the transmittance axis of the first polarization film 140, and thus the light is transmitted from the first polarization film 140. The light transmitted from the first polarization film 140 is re-supplied to the display panel 100. The light re-supplied to the display panel 100 has a phase substantially parallel to the transmittance axis of the second polarization film 150 after passing through the liquid crystal layer 130. Therefore, the light passing through the liquid crystal layer 130 is transmitted from the second polarization film 150 and is output to the outside of the display apparatus 500. Accordingly, the display apparatus 500 may maintain the bright state, and the viewer can view the images via the display apparatus 500.

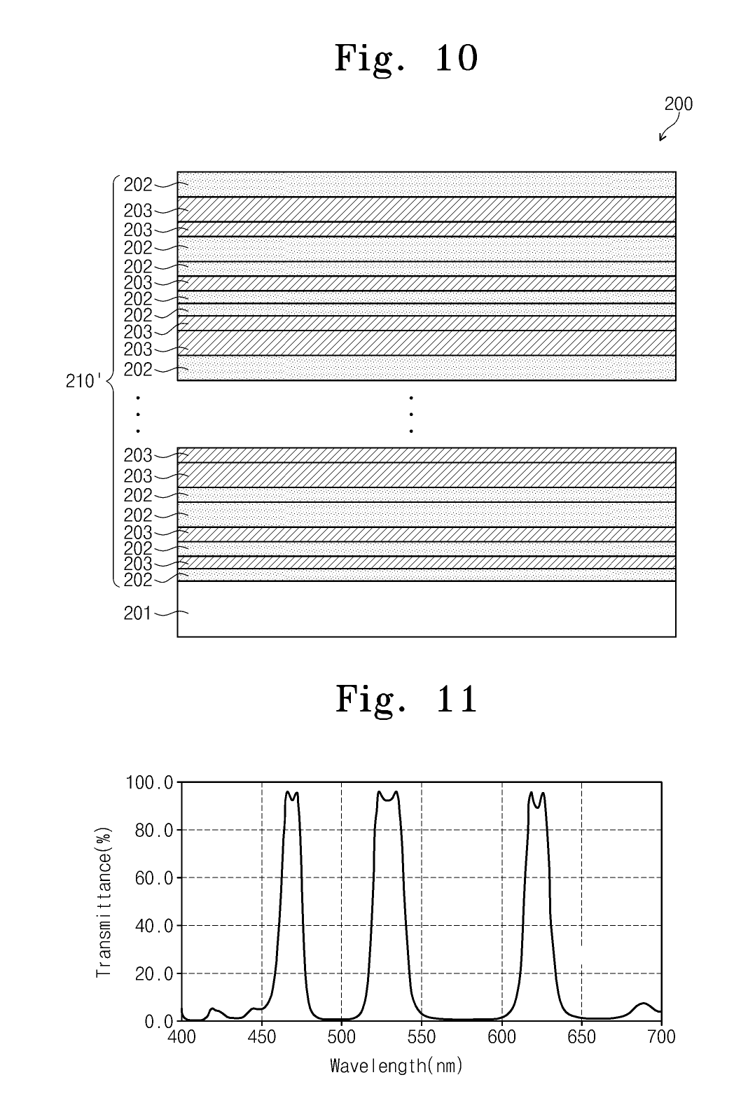

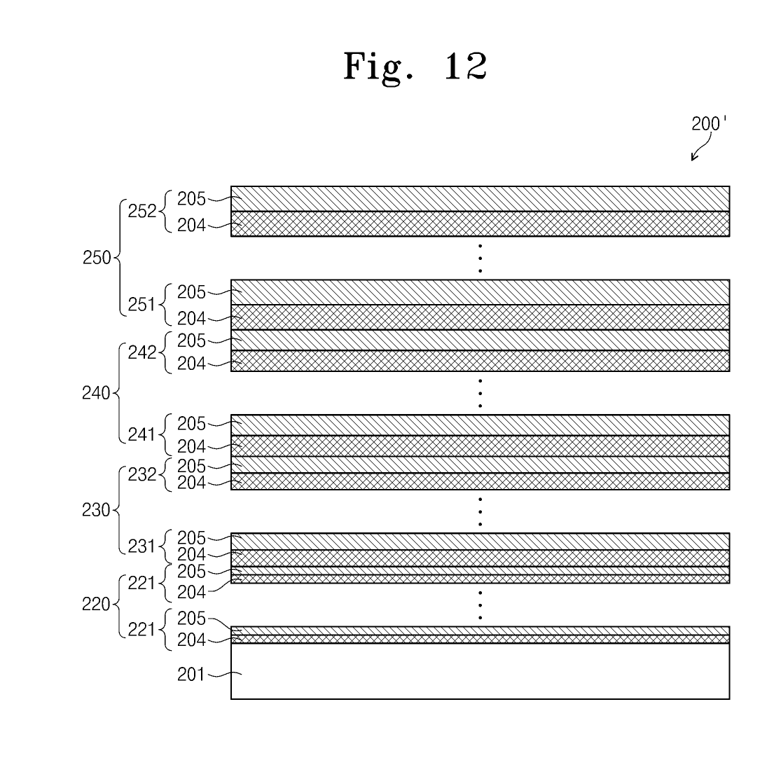

FIG. 9 and FIG. 10 are cross-sectional views illustrating the wavelength selective transflective member shown in FIG. 1. FIG. 11 is a graph illustrating light transmitted from the wavelength selective transflective member shown in FIG. 9 and FIG. 10.

Referring to FIG. 9 to FIG. 11, the wavelength selective transflective member 200 includes a base substrate 201 and a multi-cavity band pass filter 210, 210′ disposed on the base substrate 201.

The base substrate 201 comprises a material, such as a transparent glass or a transparent plastic capable of transmitting the light.

The multi-cavity band pass filter 210 and 210′ may transmit the light of a plurality of wavelength bands. For example, the multi-cavity band pass filter 210 and 210′ may transmit a first light having a first wavelength band of about 463 nm to about 475 nm, a second light having a second wavelength band of about 520 nm to about 538 nm, and a third light having a third wavelength band of about 614 nm to about 630 nm.

In addition, the multi-cavity band pass filter 210 and 210′ may reflect the light having wavelength bands other than the first to third wavelength bands. The light transmitted from the wavelength selective transflective member 200 may have a spectrum characteristic as shown in FIG. 11 by the multi-cavity band pass filter 210 and 210′.

The multi-cavity band pass filter 210 and 210′ may comprise a plurality of first layers 202 and a plurality of second layers 203, and the first and second layers 202, 203 have a different refractive index from each other. More specifically, as shown in FIG. 9, the multi-cavity band pass filter 210 has a structure that alternately stacks the first layers 202 and the second layers 203. Meanwhile, as shown in FIG. 10, the multi-cavity band pass filter 210′ has a structure that randomly stacks the first layers 202 and the second layers 203.

The first and second layers 202 and 203 have a refractive index of about 1.35 to about 2.35. In the exemplary embodiment, the first layers 202 have a refractive index less than that of the second layers 203. Also, a difference of the refractive index between the first layers 202 and the second layers 203 is more than about 0.1. For example, the first layers 202 include a silicon oxide, such as SiO2 having a refractive index of about 1.45 and are capable of transmitting the light. The second layers 203 include a metal oxide, such as TiO2 having a reflective ratio of about 2.35 and are capable of transmitting the light.

The first layers 202 have a different thickness from each other, and the second layers 203 have a different thickness from each other.

Hereinafter, another exemplary embodiment of the present invention will be described. In FIG. 12 to FIG. 21, elements substantially the same as elements shown in FIG. 1 to FIG. 11 have a same reference number, and a detailed description for the elements will be omitted. To avoid duplicate description, referring to FIG. 12 to FIG. 21 will mainly explain differences between FIG. 1 to FIG. 11 and FIG. 12 to FIG. 21.

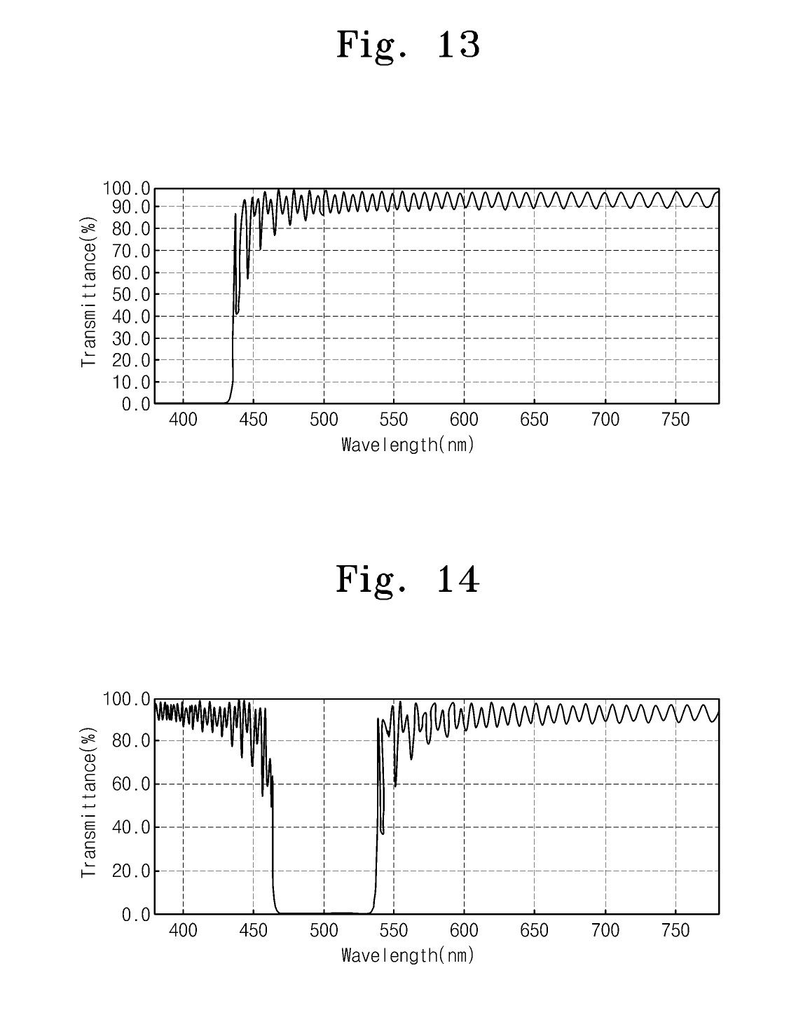

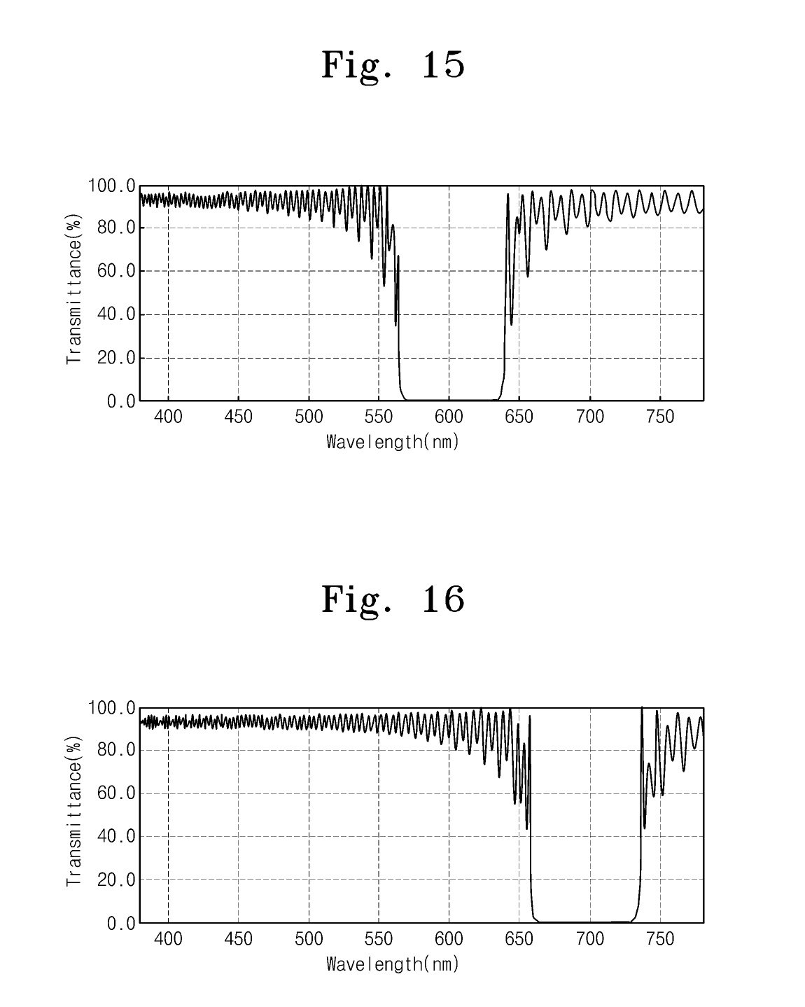

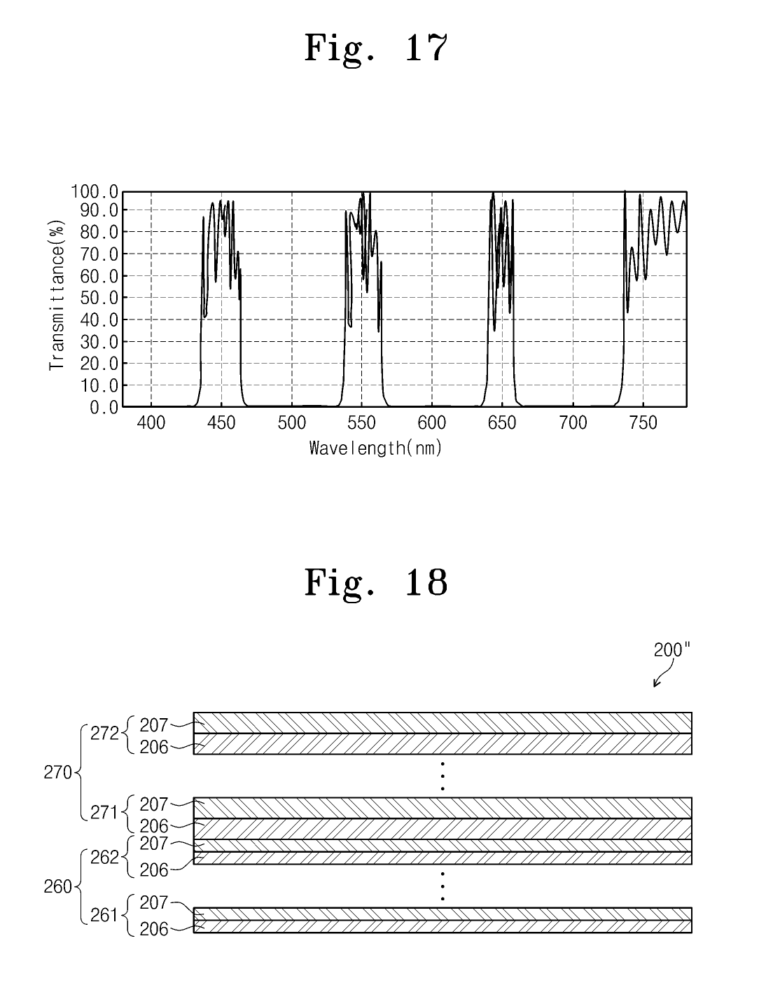

FIG. 12 is a cross-sectional view illustrating a wavelength selective transflective member used in a display apparatus according to an exemplary embodiment of the present invention. FIG. 13 to FIG. 16 are graphs illustrating a spectrum of a light transmitted from each filter unit of the wavelength selective transflective member shown in FIG. 12. FIG. 17 is a graph illustrating a spectrum of a light transmitted from the wavelength selective transflective member shown in FIG. 12.

Referring to FIG. 12 to FIG. 17, the wavelength selective transflective member 200′ comprises a base substrate 201 and a plurality of filter units 220, 230, 240, 250 disposed on the base substrate. The filter units 220, 230, 240, 250 reflect lights of different wavelength bands. As shown in FIG. 12, the wavelength selective transflective member 200′ comprises a first filter unit 220 disposed on the base substrate 201, a second filter unit 230 disposed on the first filter unit 220, a third filter unit 240 disposed on the second filter unit 230, and a fourth filter unit 250 disposed on the third filter unit 240.

Each of the first to fourth filter units 220, 230, 240, 250 comprises a first sub-filter unit 221, 231, 241, 251 and a second sub-filter units 222, 232, 242, 252. The first sub-filter units 221, 231, 241, 251 of the first to fourth filter units 220, 230, 240, 250 have a different overlap coefficient from each other, and the second sub-filter units 222, 232, 242, 252 of the first to fourth filter units 220, 230, 240, 250 have a different overlap coefficient from each other. In addition, the first sub-filter units 221, 231, 241, 251 of each filter unit 220, 230, 240, 250 have the overlap coefficient less than corresponding one of the second sub-filter units 222, 232, 242, 252 of the each filter unit 220, 230, 240, 250. In the exemplary embodiment, the overlap coefficient is defined as a ratio of a center wavelength of the reflected light for a center wavelength of the incident light to the wavelength selective transflective member 200′. For example, because the wavelength selective transflective member 200′ receives the light of the visible light wavelength band, the center wavelength of the incident light is about 550 nm.

Each of the first and second sub-filter units 221, 222, 231, 232, 241, 242, 251, 252 comprises a third layer 204 and a fourth layer 205 disposed on the third layer 204. The third and fourth layers 204 and 205 comprise a transparent organic polymer and have a different refractive index from each other. In particular, each of the third and fourth layers 204 and 205 may have a refractive index of about 1.5 to about 1.8. The third layer 204 has a refractive index greater than that of the fourth layer 205, and a difference of the refractive index between the third layer 204 and the fourth layer 205 is more than about 0.05. In the exemplary embodiment, the third layer 204 comprises a polyethylene naphthalate having a refractive index of about 1.8, and the fourth layer 205 comprises a polyethylene terephthalate having a refractive index of about 1.6.

The first filter unit 220 reflects a light (hereinafter, a fourth light) having a predetermined wavelength band (hereinafter, a fourth wavelength band) and transmits a light having a remained wavelength band other than the fourth wavelength band. In the exemplary embodiment, the first filter unit 220 has a structure that stacks the first sub-filter unit 221 having the overlap coefficient of about 0.71 about 50 times and stacks the second sub-filter unit 222 having the overlap coefficient of about 0.76 about 50 times. The first filter unit 220 reflects the light having a wavelength less than about 430 nm and transmits the light having a wavelength more than about 430 nm. Therefore, the light transmitted from the first filter unit 220 may have a spectrum characteristic as shown in FIG. 13.

The second filter unit 230 reflects a fifth light having the fifth wavelength band that does not overlap with the fourth wavelength band and transmits a light having a remained wavelength band beside the fifth wavelength band. In the exemplary embodiment, the second filter unit 230 has a structure that stacks the first sub-filter unit 231 having the overlap coefficient of about 0.88 about 50 times and stacks the second sub-filter unit 232 having the overlap coefficient of about 0.94 about 50 times. The second filter unit 230 reflects the light having a wavelength band of about 465 nm to about 535 nm and transmits the light having a wavelength band beside the wavelength band of about 465 nm to about 535. Therefore, the light transmitted from the second filter unit 230 may have a spectrum characteristic as shown in FIG. 14.

The third filter unit 240 reflects a sixth light having the sixth wavelength band that does not overlap with the fourth and fifth wavelength bands and transmits a light having a wavelength band other than the sixth wavelength band. In the exemplary embodiment, the third filter unit 240 has a structure that stacks the first sub-filter unit 241 having the overlap coefficient of about 1.07 about 50 times and stacks the second sub-filter unit 242 having the overlap coefficient of about 1.12 about 50 times. The third filter unit 240 reflects the light having a wavelength band of about 570 nm to about 640 nm and transmits the light having a wavelength band beside the wavelength band of about 570 nm to about 640. Therefore, the light transmitted from the third filter unit 240 may have a spectrum characteristic as shown in FIG. 15.

The fourth filter unit 250 reflects a seventh light having the seventh wavelength band that does not overlap with the fourth to sixth wavelength bands and transmits a light having a wavelength band other than the seventh wavelength band. In the exemplary embodiment, the fourth filter unit 250 has a structure that stacks the first sub-filter unit 251 having the overlap coefficient of about 1.25 about 50 times and stacks the second sub-filter unit 252 having the overlap coefficient of about 1.29 about 50 times. The fourth filter unit 250 reflects the light having a wavelength band of about 660 nm to about 735 nm and transmits the light having a wavelength band other than the wavelength band of about 660 nm to about 735. Therefore, the light transmitted from the fourth filter unit 250 may have a spectrum characteristic as shown in FIG. 16.

Accordingly, the light which is transmitted from the wavelength selective transflective member 200′ comprising the first to fourth filter units 220, 230, 240 and 250 has a spectrum characteristic as shown in FIG. 17.

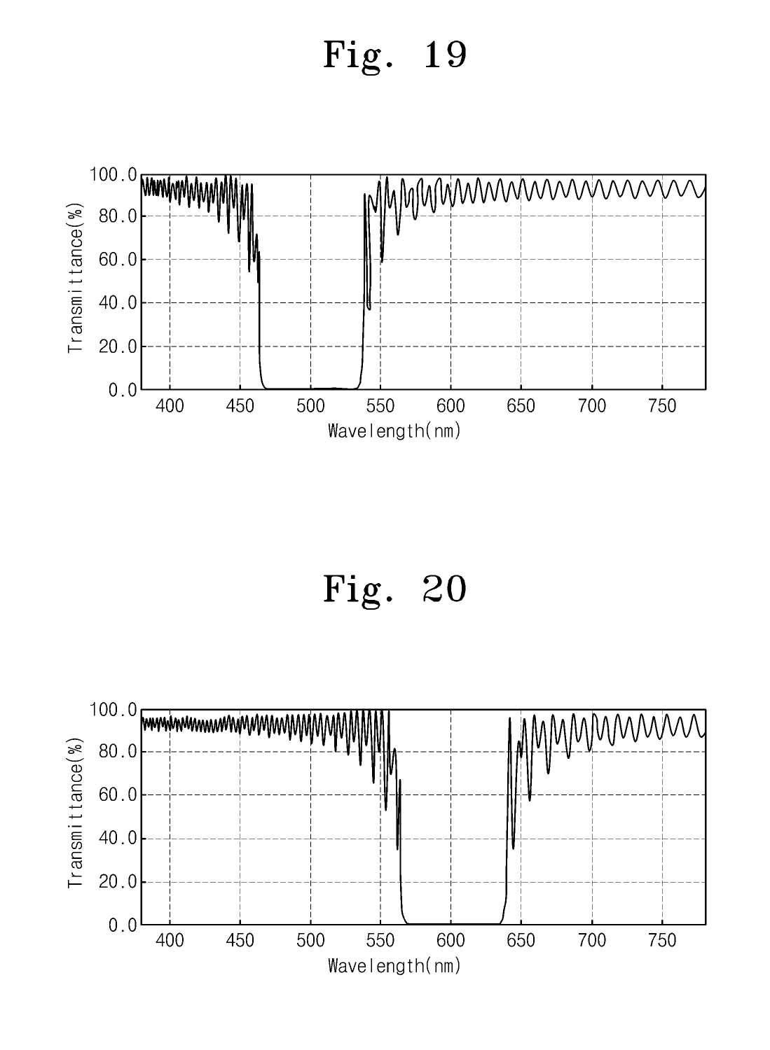

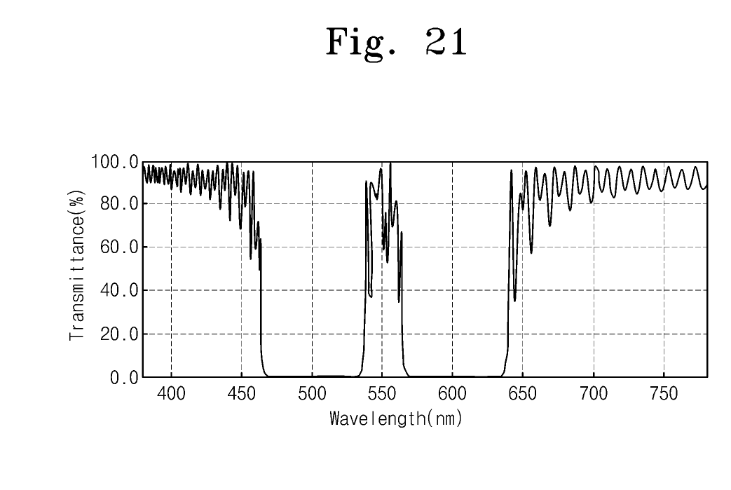

FIG. 18 is a cross-sectional view showing a wavelength selective transflective member used in a display apparatus according to an exemplary embodiment of the present invention. FIG. 19 and FIG. 20 are graphs showing a spectrum of a light transmitted from each filter unit of the wavelength selective transflective member shown in FIG. 18. FIG. 21 is a graph showing a spectrum of a light transmitted from the wavelength selective transflective member shown in FIG. 18.

Referring to FIG. 18 to FIG. 21, the wavelength selective transflective member 200″ comprises a plurality of filter units 260 and 270 capable of reflecting lights of different wavelength bands. As shown in FIG. 18, the wavelength selective transflective member 200″ comprises a fifth filter unit 260 and a sixth filter unit 270 disposed on the fifth filter unit 260.

Each of the fifth and sixth filter units 260 and 270 comprises a third sub-filter unit 261 and 271 and a fourth sub-filter unit 262 and 272. The third sub-filter unit 261 of the fifth filter unit 260 and the third sub-filter unit 271 of sixth filter unit 270 have a different overlap coefficient from each other, and the fourth sub-filter unit 262 of the fifth filter unit 260 and the fourth sub-filter unit 272 of the sixth filter unit 270 have a different overlap coefficient from each other.

Each of the third and fourth sub-filter units 261, 262, 271, 272 comprises a first film 206 and a second film 207 disposed on the first film 206. The first and second films 206 and 207 comprise a transparent organic polymer and have a different refractive index from each other. In particular, each of the first and second films 206 and 207 may have a refractive index of about 1.5 to about 1.8. The first film 206 has a refractive index greater than that of the second film 207, and a difference of the refractive index between the first film 206 and the second film 207 is more than about 0.05. In the exemplary embodiment, the first film 206 comprises a polyethylene naphthalate having a refractive index of about 1.8, and the second film 207 comprises a polyethylene terephthalate having a refractive index of about 1.6.

The fifth filter unit 260 reflects a fifth light having a fifth wavelength band and transmits a light having a remaining wavelength band other than the fifth wavelength band. In the exemplary embodiment, the fifth filter unit 260 has a structure that stacks the third sub-filter unit 261 having the overlap coefficient of about 0.88 about 50 times and stacks the fourth sub-filter unit 262 having the overlap coefficient of about 0.94 about 50 times. The fifth filter unit 260 reflects the light having a wavelength band of about 465 nm to about 535 nm and transmits the light having a wavelength band other than the wavelength band of about 465 nm to about 535 nm. Therefore, the light transmitted from the fifth filter unit 260 may have a spectrum characteristic as shown in FIG. 19.

The sixth filter unit 270 reflects a sixth light having a sixth wavelength band different from the fifth wavelength band and transmits a light having a remaining wavelength band other than the sixth wavelength band. In the exemplary embodiment, the sixth filter unit 270 has a structure that stacks the third sub-filter unit 271 having the overlap coefficient of about 1.07 about 50 times and stacks the fourth sub-filter unit 272 about 50 times having the overlap coefficient of about 1.12. The sixth filter unit 270 reflects the light having a wavelength band of about 570 nm to about 640 nm and transmits the light having a wavelength band beside the wavelength band of about 570 nm to about 640 nm. Therefore, the light transmitted from the sixth filter unit 270 may have a spectrum characteristic as shown in FIG. 20.

Accordingly, the light which transmits the wavelength selective transflective member 200″ comprising the fifth and sixth filter units 260 and 270 has a spectrum characteristic as shown in FIG. 21.

According to the above, the display apparatus may use an entire region of each pixel in a transmissive mode and a reflective mode. Therefore, the brightness and resolution of the display apparatus may be improved.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A display apparatus comprising:
a display panel configured to display an image; and
a member configured to transmit a light corresponding to a plurality of separated wavelength bands of an incident light, to reflect a light corresponding to at least one remaining wavelength band, and to provide the display panel with the transmitted light or the reflected light.

2. The display apparatus of claim 1, wherein the separated wavelength bands comprise a first wavelength band, a second wavelength band and a third wavelength band.

3. The display apparatus of claim 2, wherein the member comprises:
a substrate; and
a filter disposed on the substrate, the filter configured to transmit a light corresponding to the first, second, and third wavelength bands and to reflect a light corresponding to the at least one of remaining wavelength band other than the first, second, and third wavelength bands.

4. The display apparatus of claim 3, wherein the first wavelength band has a range of about 463 nm to about 475 nm, the second wavelength band has a range of about 520 nm to about 538 nm, and the third wavelength band has a range of about 614 nm to about 630 nm.

5. The display apparatus of claim 3, wherein the filter comprises a plurality of first layers and a plurality of second layers, and
the first and second layers have a different refractive index from each other.

6. The display apparatus of claim 5, wherein the first and second layers comprise a refractive index of about 1.35 to about 2.35, and
a difference of the refractive index between the first layers and the second layers is greater than about 0.1.

7. The display apparatus of claim 6, wherein the first and second layers comprise a light transmittable oxide material.

8. The display apparatus of claim 7, wherein the first layers comprise SiO2 and the second layers comprise TiO2.

9. A display apparatus comprising:
a display panel configured to display an image; and
a member configured to transmit a light corresponding to at least one wavelength band of an incident light, to reflect a light corresponding to a plurality of remaining wavelength bands, and to provide the display panel with the transmitted light or the reflected light,
wherein the member comprises:
a substrate; and
a plurality of filter units disposed on the substrate, the filter units configured to reflect a light corresponding to the plurality of separated wavelength bands of the remaining wavelength bands.

10. The display apparatus of claim 9, wherein the separated wavelength bands comprise a first wavelength band, a second wavelength band, a third wavelength band and a fourth wavelength band, and
the filter units comprise:
a first filter unit disposed on the substrate and configured to reflect a light corresponding to the first wavelength band;
a second filter unit disposed on the first filter unit and configured to reflect a light corresponding to the second wavelength band, wherein the second wavelength band does not overlap with the first wavelength band;
a third filter unit disposed on the second filter unit and configured to reflect a light corresponding to the third wavelength band, wherein the third wavelength band does not overlap with the first and second wavelength bands; and
a fourth filter unit disposed on the third filter unit and configured to reflect a light corresponding to the fourth wavelength band, wherein the fourth wavelength band does not overlap with the first to third wavelength bands.

11. The display apparatus of claim 10, wherein each of the first to fourth filter units comprises a first sub-filter unit and a second sub-filter unit,
wherein the first sub-filter units of the first to fourth filter units have a different overlap coefficient from each other, and the second sub-filter units of the first to fourth filter units have different overlap coefficient from each other.

12. The display apparatus of claim 11, wherein the first sub-filter unit has an overlap coefficient less than that of the second sub-filter unit.

13. The display apparatus of claim 11, wherein each of the first and second sub-filter units comprises a first layer and a second layer, and
the first and second layers have a different refractive index from each other.

14. The display apparatus of claim 13, wherein each of the first and second layers comprises an organic polymer having a refractive index of about 1.5 to about 1.8.

15. The display apparatus of claim 14, wherein a difference of the refractive index between the first layer and the second layer is more than about 0.05.

16. The display apparatus of claim 15, wherein the first layer comprises a polyethylene naphthalate, and the second layer comprises a polyethylene terephthalate.

17. The display apparatus of claim 10, wherein the first wavelength band has a range of less than about 430 nm, the second wavelength band has a range of about 465 nm to about 535 nm, the third wavelength band has a range of about 614 nm to about 630 nm, and the fourth wavelength band has a range of about 660 nm to about 735 nm.

18. The display apparatus of claim 9, wherein the separated wavelength bands comprise a first wavelength band and a second wavelength band, and
the member comprises:
a first filter unit configured to reflect a light corresponding to the first wavelength band; and
a second filter unit configured to reflect a light corresponding to the second wavelength band, wherein the second wavelength band does not overlap with the first wavelength band,
wherein each of the first and second filter units comprises a sub-filter unit and a sub-filter unit, and
wherein each of the first and second sub-filter units comprises a first film and a second film, the first film and the second film each comprising an organic polymer having a different refractive index from each other.

19. The display apparatus of claim 18, wherein the first sub-filter unit has an overlap coefficient less than that of the second sub-filter unit.

20. The display apparatus of claim 18, wherein the first film comprises a polyethylene naphthalate, and the second film comprises a polyethylene terephthalate.

21. The display apparatus of claim 9, further comprising a backlight unit configured to provide the member with the incident light, and
wherein the member is disposed between the display panel and the backlight unit.
